(19) United States
(12) Patent Application Publication
(10) Pub. No.: US 2011/0215509 A1
(43) Pub. Date: Sep. 8, 2011

(54) METHOD OF MANUFACTURING A CONTAINER

(75) Inventor: Albert Wauters, Destelbergen (BE)

(73) Assignee: Anheuser-Busch InBev S.A., Brussels (BE)

(21) Appl. No.: 12/449,492

(22) PCT Filed: Feb. 12, 2008
(86) PCT No.: PCT/EP2008/051688

§ 371 Date: May 23, 2011

(30) Foreign Application Priority Data
Feb. 12, 2007 (GB) 0702671.9
Dec. 14, 2007 (GB) 0724453.6

(51) Int. Cl. B29D 22/00; B29C 71/00

(52) U.S. Cl. 264/572; 264/232

(57) ABSTRACT

A method of manufacturing an article, the method comprising the steps of molding a melt of thermoplastic material thereby forming said article and cooling the article to a temperature below the glass temperature of said thermoplastic material, characterized in that the method further comprises a post treatment of applying a stress on the article.

### FIELD OF THE INVENTION

The present invention relates to a method of manufacturing an article, in particular of manufacturing a container of thermoplastic material.

### BACKGROUND OF THE INVENTION

It is known to manufacture containers in a thermoplastic material by a process generally known as blow-molding. Blow-molding processes are employed in the production of hollow-bodied thermoplastic articles including, in particular, containers such as bottles. The basic process entails the production of pre-shaping the thermoplastic material into an intermediate for that is referred to as a parison or preform. The heated preform is then further shaped by inflating it under gas pressure, within the constraints of a mold cavity that is designed to provide the final shape of the article.

At present there is a permanent demand for decreasing the cost of production and an important factor therein is reducing the production cycle time, without any concessions to quality of the container in terms of physical properties or product quality keeping.

U.S. Pat. No. 4,512,948, U.S. Pat. No. 4,853,171 and U.S. Pat. No. 4,839,127 describe methods for shortening the production cycle time for blow-molding containers of thermoplastic material such as polyethylene-terephthalate. According to both prior art documents, a preform is formed and subsequently shaped by inflating under gas pressure, forming a container. Once the container is formed, it needs to be cooled. In order to shorten cooling time and thus production cycle time, U.S. Pat. No. 4,512,948 discloses that during a first cooling the containers interior needs to be kept under pressure to prevent shrinkage. Once the container is sufficiently cooled to prevent strong shrinkage thereof, the internal pressure is released and the container can be removed from the mold. According to U.S. Pat. No. 4,512,948, the disclosed method allows to release the container from the mold at a temperature above 100° C., thereby reducing the production cycle time.

An inconvenience of the known methods is that the known production methods do not take in account the effect of the viscoelastic behavior of the thermoplastic material.

Indeed, even when cooled, the blow-molded thermoplastic containers is subjected to a permanent stretch, affecting the interior volume of the container. The viscoelastic behavior of the thermoplastic material, manifests in two ways that are important in container manufacturing. The first is a time dependent modulus associated with stress-relaxation within the material—and is known as post molding shrink. The second is the materials time dependent compliance to applied stress—as in the case of the super-atmospheric pressure exerted by the containers contents—for example carbonated beverages. The property is referred to as creep, or sometimes “cold flow”.

In normal conditions, i.e. at room temperature and ambient pressure, the stress-relaxation (shrink) can take up to three days to finish manifesting, and subsequent growth (creep, or more specifically cold flow is done at room temperature), requires a further seven days to complete—so that there is a ten day hiatus between molding and filling of the container.

Presently, there are two options to deal with viscoelastic behavior. A first option is to ignore its effect and to fill the container relatively short after cooling down. In this case the internal volume of the container is subject to changes and will attain its nominal (final) volume only after filling. Hence, the free volume or head space of the container, i.e. the part of the container that is left empty when filling it with liquid, changes. Such change however is undesired when the container contains gasified liquids, since changes in the head space will lead to a shift in the equilibrium of the gas above the liquid and in the liquid and thus to the composition of the liquid. Particularly for beverages such change in composition is to be avoided since it may lead to taste deterioration.

Another option to deal with the viscoelastic behavior of the thermoplastic material is to store the containers for a period of up to ten days after cooling as that is the time needed for the container to reach its nominal volume.

It is apparent however that storing containers for such long period necessitates large storage areas and thus negatively affects the manufacturing cost.

The goal of the present invention is to overcome the above and other drawbacks.

### SUMMARY OF THE INVENTION

Therefore the invention concerns a method of manufacturing an article, the method comprising the steps of molding a melt of thermoplastic material thereby forming said article and cooling the article to a temperature below the glass temperature of said thermoplastic material, characterized in that the method further comprises a post treatment of applying a stress on the article.

Preferably, the stress on the article is applied in a direction contrary to deformation of the article due to stress-relaxation of the thermoplastic material.

The present invention particularly relates to the above method for manufacturing a container and preferably a keg of thermoplastic material, whereby the post treatment comprises applying an overpressure in the container or keg.

The present invention also concerns a method for flushing a container of molded thermoplastic material, by inserting a fluid therein under pressure, characterized in that said fluid is inserted in the container when the container is subject to stress-relaxation of the thermoplastic material and holding said fluid under pressure in the container for a period corresponding at least part of the period wherein the container is subject to stress-relaxation.

### DETAILED DESCRIPTION OF THE PRESENT INVENTION

In accordance with general practice, an article of a thermoplastic material can be shaped by molding. For containers and especially bottles, the manufacturing process starts with making a parison or preform. Such parison or preform is known to be manufactured by means of extrusion or injection molding.

The parison or preform can subsequently be blow-molded in a mold to form the desired article such as a container. Depending on the process applied for manufacturing the parison, following processes can be applied to manufacture the container.

Extrusion blow molding is currently the most widely used of these techniques and it consists of extruding, (either intermittently or continuously), a hollow parison in a downward dropping direction. When the parison has grown sufficiently, a predetermined length thereof is embraced within a mold cavity. Once the parison is engaged within the mold, it is inflated under gas pressure and conforms to the rigid internal surfaces of the enclosing mold, taking on a hollow-bodied shape that will ultimately lead to that of the finished container.

Injection blow molding is a multi-stage operation in which the parison is injection molded into a space defined by a parison mold and a core rod disposed therein and is then transferred (e.g. on the core rod) into a subsequent blow-molding station. In a “displacement” variant of this type of blow molding, a measured quantity of thermoplastic melt is inserted in a parison mold, and the core rod is then inserted into the mold to forcibly displace the melt into the spaces remaining between the core rod and the molds inner surfaces—thus forming the parison.

With respect to the blow-molding process it is remarked that stretch blow molding is particularly suited to applications involving thermoplastics capable of taking up internal linear molecular orientations—such as PET. The parison can be either extrusion molded or injection molded, although the latter is most often used in association with stretch blow molding operations. What specifically characterizes the stretch blow mold process is that the preformed parison is carefully conditioned to just above the thermoplastic's glass transition temperature (i.e. where it is warm enough to permit the parison to be inflated but cool enough to retard post-alignment re-randomization of the molecular structure), and then stretched, oriented (“partial” and axially or bi-axially) and blown. The strain-induced crystallization in the stretched thermoplastic can, in the case of PET be increased by as much as 20, and even to as high as 28%.

Once the container is blow-molded, it needs to be cooled. The cooling of the container can be either actively, as described in for example U.S. Pat. No. 4,512,948 and U.S. Pat. No. 4,853,171 or passively. It is clear that active cooling is preferred to shorten process cycle time.

According to the present invention a post treatment is performed after cooling the container at least below the glass temperature of the thermoplastic material. The glass temperature is the temperature below which the thermoplastic material is in its glassy state, with its polymeric structure “locked-in” in the sense that the material exhibits very high viscosity, virtually no segmental motion and very little (or at least very slow) creep.

The post treatment according to the invention comprises applying an internal pressure in the container to mitigate stress relaxation in the form of post-forming dimensional shrink.

The internal pressure—i.e. an overpressure with respect to ambient pressure—is preferably applied by inserting a fluid in the container and sealing the container such that the overpressure can be maintained for a certain period.

Preferably the containers interior is held under sufficient pressure and for at least sufficient time to substantially avoid post-forming dimensional shrink of said container and preferably even longer to grow the container through creep. In the case of containers such as 10 to about 50 liter kegs made from polyethylene therephthalate (PET) or polyethylene naphthalate (PEN) and with an internal pressure comprised between 1.5 and 4 bar, the post-forming dimensional shrink can last for about 1 day, while the subsequent creep will manifest itself up to 5 more days, resulting in a 6 to 7 day period before the container reaches dimensional stability.

Using internal overpressure in accordance with the present invention allows to exert a complex stress field across the container—mitigating the manifestation of relaxation-stress related shrink and, in the case of pressurized containers such as those for carbonated beverages such as beer, the invention also shortens the time required to creep condition (or “grow”) the container up to its final desired dimensions.

In view of the known methods where no internal pressure is applied in the container after sufficient cooling, the present invention allows a reduction of the required hold time by 30%—i.e. down to seven days.

In addition, the containers manufactured by a method according the present invention have reached their nominal volume before filling with their intended content, thereby preventing organoleptic deterioration of the content, especially of carbonated drinks such as beer.

In order to maintain the containers interior under pressure, it is preferred that the container is ejected from the mold wherein it is blow-molded or from a cooling mold if applied, and is provided with a valve assembly, sealing the containers interior.

Once sealed, the container can be filled through the valve assembly with a fluid to create overpressure. The fluid preferably is a non-oxidative gas such as carbon dioxide or nitrogen.

This has the additional advantage that the integrity of the container and of the connection with the valve assembly can be tested during the post treatment in accordance with the invention. In addition to the foregoing, the practice of the present invention can be collaterally employed to test packaging integrity issues. In such a case, the fluid pressure can be elevated for at least some period of time to be sufficient to conduct a container integrity pressure testing regimen compliant with applicable regulatory and or healthy/safety and/or quality standards. Accordingly and since the kegs have to be pressure tested anyway, the method according to the invention of filling and holding them with fluid makes a lot of sense. The British Beer and Pub Association issues the instruction that all pressure kegs “shall be tested at the manufacturer's works to at least 1.5 times their Safe Working Pressure,” this SWP being “the maximum gauge pressure to which equipment should be subjected and which must not be exceeded by any planned method of working.” Even during filling and dispense using mixtures of carbon dioxide and nitrogen, the pressures in kegs should rarely exceed 3 bar (50 psig). All containers made in Europe (whether kegs or casks) are designed for a working pressure of 4 bar (60 psig) and every one is tested at manufacture and after repair to 6 bar (90 psig). It further stipulates that “the maximum test pressure should not subject the material to stresses in excess of 90% of the minimum specified yield for the material [and that it] shall be maintained for a sufficient length of time to permit a thorough examination to be made of all seams and joints.”

Other for testing purposes however, it is preferred to employ pressures that correspond to the pressure exerted by a contained gasified beverage, during the kegs normal usage. For most purposes, this will relate to the use of carbon dioxide in an amount of about 12 grams or less per liter of container volume to pressurize the container—particularly for club soda or ginger ale type beverages. An amount of about 2 grams per liter or more might be associated with sparkling fruit juices or the like. For beer, carbon dioxide could be present in an amount of about 6 grams per liter.

In an especially preferred practice according to the method of the present invention, the container is a closed-system keg that is adapted to be filled with beer without materially dropping its internal pressurization below the pressure exerted by the fluid inserted therein for post treatment. In the normal course, for example, a beer keg is filled and distributed under pressure. Once connected to a dispense system, carbon dioxide is introduced under pressure to drive beer out of the container and on to the beer tap from which it is dispensed. In this way, the keg is always pressurized.

It is noted that the present invention has special application in relation to “gasified” beverage containers—since the application of the internal pressure not only reduces the time required to overcome shrink, but forces creep to drive the container to its street level dimensions. Gasified beverages that contain carbon dioxide; nitrogen or mixtures thereof are typical of those for which kegs of the present invention can be used.

Of the gasified beverages, particular advantages can accrue for beverages such as beer, and also to other beverages—whether gasified or not—that are sensitive to in-package oxidation. In this latter connection, the growth of the container resulting from creep driven by the use of non-oxidative gases such as carbon dioxide and/or nitrogen according to the present invention can collaterally displace oxygen from the interior volume, flushes it from the interior surfaces, and migrate into the molecular interstices of the thermoplastic, thereby displacing oxygen from within the thermoplastic material. This is important because sensory changes in a beer after packaging, are undesirable and every brewer attempts to avoid such beer damage.

In accordance with the advantages listed above, the invention also relates to a method for flushing a container of molded thermoplastic material, by inserting a fluid therein under pressure, characterized in that said fluid is inserted in the container when the container is subject to stress-relaxation of the thermoplastic material and holding said fluid under pressure in the container for a period corresponding at least part of the period wherein the container is subject to stress-relaxation.

Further, it will be appreciated that the thermoplastic material to be used the method according the invention for manufacturing the article is not limited to either PET or PEN.

Indeed, most thermoplastics can be blow molded, even if filled with glass and minerals (fiberglass, talc, mica). What determines the usefulness of thermoplastics for blow molding are the necessary characteristics and behavior imposed on the material by the process. Important material characteristics are melt flow and melt strength, (especially in extrusion blow molding where the extruded parison must be able to support its own weight without tearing). As a generalization such materials typically have fractional melt index, high molecular weight and high melt strength.

Polyolefins are the most commonly used materials—high density polyethylene, HDPE, linear low density polyethylene, LLDPE, polypropylene, PP. These materials have high melt strength, wide temperature processing windows, do not require drying, can be re-processed with little loss of properties, are resistant to many chemicals, and are relatively soft so flash removal is easy.

Polyethylene-terephthalate, PET, and polyvinyl chloride, PVC, can be processed to have high clarity and high impact strength. For some applications this requires an orientation process (axial or biaxial) to develop the desirable properties- and this is best controlled by way of stretch-blow molding. Note that injection blow molding of PET bottles is typically done with standard PET bottle resin. Extrusion blow molding of bottles on the other hand, benefits from the use of slow-crystallizing copolymeric PET having improved (higher, in this case) melt strength.

Increased impact strength, greater temperature resistance and improved fatigue behavior are available with engineered plastics and alloys and blends, e.g., polycarbonate, PC, acrylonitrile-butadiene-styrene, ABS, polyurethane, nylon, polyphenylene oxide/polystyrene, PPO/PS, polyphenylene oxide/nylon, PC/ABS.

Most rheological behavior is determined by the composition and structure of the polymer, temperature and shear rate, however, processing and material additions can have effects. Re-processed or regrind material may have different viscosity and melt strength due the shear and heating experienced by the material in previous processing. Fillers do not deform in the same way as the thermoplastic and so influence flow during parison formation and part blowing.

To summarize and in accordance with the present invention, the container is “tempered” by having it's interior held under sufficient pressure and for at lease sufficient time to substantially avoid post-forming dimensional shrink of the container due to time decaying viscoelastic response associated with residual formation-stress relaxation in the thermoplastic material. More specifically, the container's interior is held under pressure exerted by a fluid occupying the volume in sealed relation within the interior space, after the container has been released from a mold in which the melt was formed. In accordance with a particularly preferred practice, the container is released from the mold in which the melt was formed, where after fluid is introduced into the container's interior to exert the pressure. The container is released from the mold, and then sealed with valve means through which the fluid is then introduced into the container's interior to exert the pressure.

Preferably the container is tempered in the further sense that sufficient pressure is applied for at least sufficient time to grow said container through creep compliance to said containers street fill dimensions. More particularly, a preferred container is tempered in that a sufficient pressure is applied for at least sufficient time to grow said container through creep compliance to said containers street fill dimensions.

The tempering of the container includes introducing the fluid into container after the thermoplastic melt's temperature has fallen below the glass transition temperature Tg thereof. In a particularly preferred form of the present invention, the container is adapted to be a beverage container. The saturating of the thermoplastic material with carbon dioxide is especially useful in the packaging of carbonated beverages.

1. A method of manufacturing an article, the method comprising the steps of molding a melt of thermoplastic material thereby forming said article and cooling the article to a temperature below the glass temperature of said thermoplastic material, characterized in that the method further comprises a post treatment of applying a stress on the article.

2. The method according to claim 1 , wherein the stress on the article is applied in a direction contrary to deformation of the article due to stress-Relaxation of the thermoplastic material.

3. The method according to claim 1, characterized in that the article is a container and that the post treatment comprises applying an overpressure in the container.

4. The method according to claim 3, characterized in that the overpressure is created by inserting and holding a fluid in the container.

5. The method according to claim 4, characterized in that said fluid is a non-oxidative fluid.

6. The method according to claim 5, characterized in that said fluid is carbon dioxide or nitrogen.

7. The method according to claim 3, characterized in that the pressure applied in the container is comprised between 1.5 and 4 bar.

8. The method according to claim 3, characterized in that the overpressure in the container is maintained for a period corresponding to at least part of the period wherein the thermoplastic material of the container is subject to stress-relaxation and/or creep.

9. The method according to claim 3, characterized in that the overpressure in the container is maintained for a period of about 7 days.

10. The method according to claim 3, characterized in that a valve assembly is mounted on the container in a sealing relationship prior to inserting the pressurized fluid.

11. The method according to claim 10, characterized in that during at least part of the post treatment, the article is situated outside a mold.

12. A method for flushing a container of molded thermoplastic material, by inserting a fluid therein under pressure, characterized in that said fluid is inserted in the container when the container is subject to stress-relaxation of the thermoplastic material and holding said fluid under pressure in the container for a period corresponding at least part of the period wherein the container is subject to stress-relaxation.

13. The method according to claim 12, characterized in that the fluid is a non-oxidative fluid, in particular carbon dioxide or nitrogen.
